(19) United States
(12) Patent Application Publication
(10) Pub. No.: US 2019/0318897 A1
(43) Pub. Date: Oct. 17, 2019

(54) APPARATUS FOR REMOVING AND INSTALLING ELEVATED LIGHT BULBS

(71) Applicant: Frank Gatski, Las Vegas, NV (US)

(72) Inventor: Frank Gatski, Las Vegas, NV (US)

(21) Appl. No.: 15/952,171

(22) Filed: Apr. 12, 2018

(51) Int. Cl. H01J 9/00; H01K 3/32

(52) U.S. Cl. CPC H01J 9/003; H01K 3/32

(57) ABSTRACT

A universal gripping unit configured for attachment to poles or handles or varying lengths to accommodate light bulbs at varying heights or elevations. The universal gripping unit includes a platform and collar; an adhesive pad attached to an upper surface of the platform; a non-adhesive cover removably attached to the adhesive pad; and a threaded female protrusion extending from an underside of the platform wherein the threaded female protrusion is configured to receive a threaded male portion of a pole or handle.

### FIELD OF THE INVENTION

The embodiments of the present invention relate to an apparatus for changing light bulbs in elevated locations such as vaulted ceilings.

### BACKGROUND

Exterior and indoor elevated lighting systems are very common and popular. One disadvantage of elevated lighting systems, whether exterior or interior, is the inconvenience and danger related to changing the associated light bulbs. For example, using a ladder to change elevated light bulbs is generally unsafe for people inexperienced at such tasks. The changing difficulties relate to any bulb type including incandescent, flood and compact fluorescent.

Thus, there exists a need for an apparatus configured to allow users to remove and install elevated light bulbs conveniently and safely.

### SUMMARY

The embodiments of the present invention relate to an apparatus comprising: a support collar; one or more adhesive members retained by said support collar; and wherein said support collar includes a universal threaded adapter for receipt of an extension pole.

In one embodiment, the one or more adhesive members reside within a recessed area of said support collar defined by an outer wall such that said useable adhesive member is substantially flush with an upper surface of said outer wall. The adhesive members have a “tacky” surface for gripping and controlling a light bulb during removal and installation.

Other variations, embodiments and features of the present invention will become evident from the following detailed description, drawings and claims.

### BRIEF DESCRIPTION OF THE DRAWINGS

FIG. 1 illustrates a side view of a support collar of an apparatus for removing a light bulb according to the embodiments of the present invention;

FIG. 2A illustrates an upper view of the support collar and adhesive members according to the embodiments of the present invention;

FIG. 2B illustrates an upper view of the support collar and adhesive members according to the embodiments of the present invention;

FIG. 3 illustrates a side view of the apparatus of FIG. 1 with a capture cone in a first position and second position;

FIG. 4 illustrates a cross-sectional view of the apparatus according to the embodiments of the present invention;

FIG. 5 illustrates individual components of the apparatus of FIG. 1 according to the embodiments of the present invention;

FIG. 6 illustrates an adhesive member according to the embodiments of the present invention;

FIG. 7 illustrates another gripping unit having a single adhesive member according to the embodiments of the present invention;

FIGS. 8A through 8D illustrate a universal gripping unit configured to attach to a pole according to the embodiments of the present invention; and

FIG. 9 illustrate the universal gripping unit and various poles according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

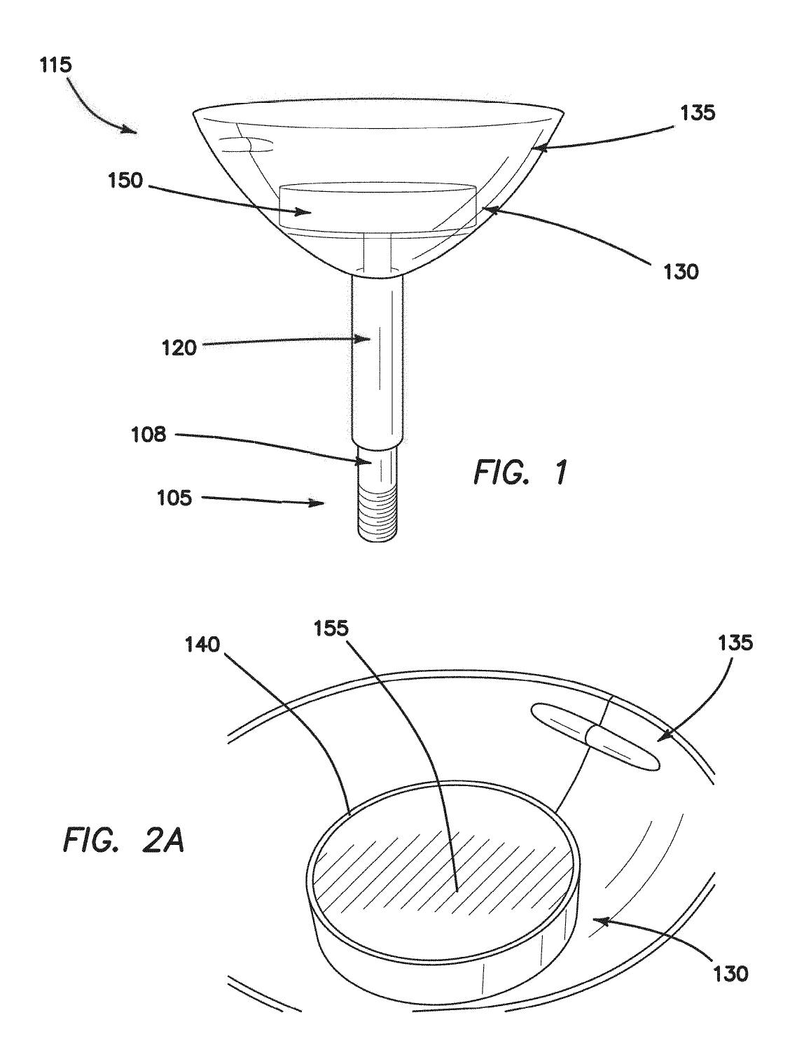

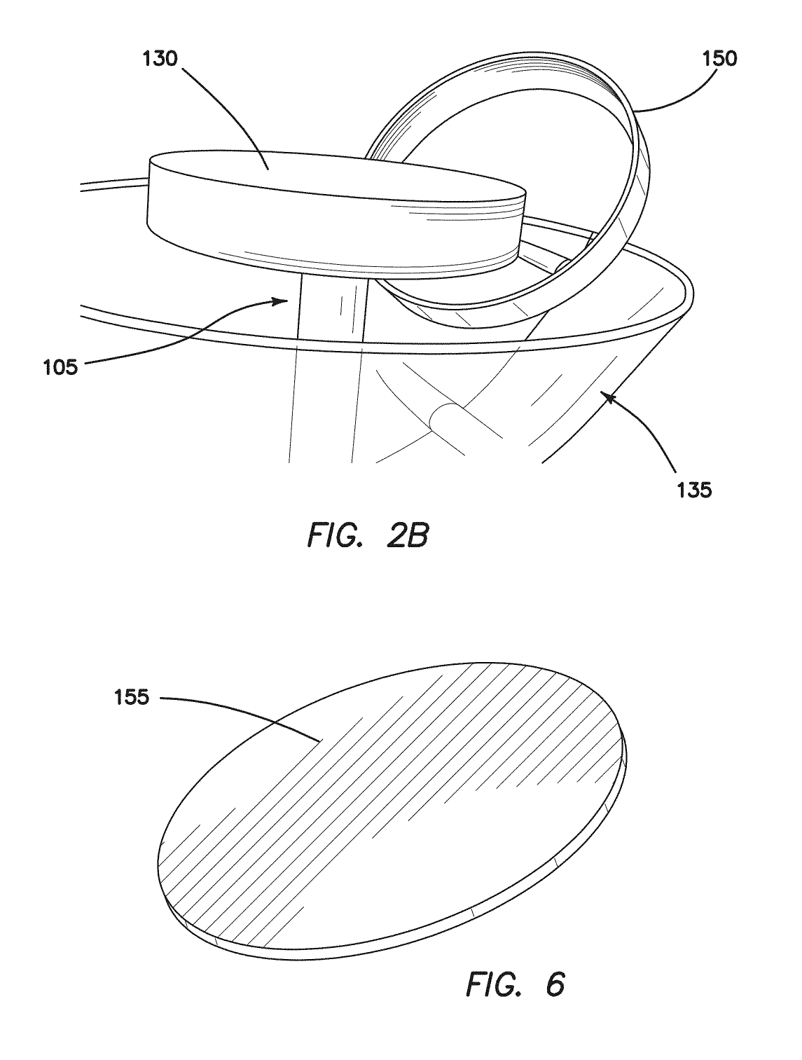

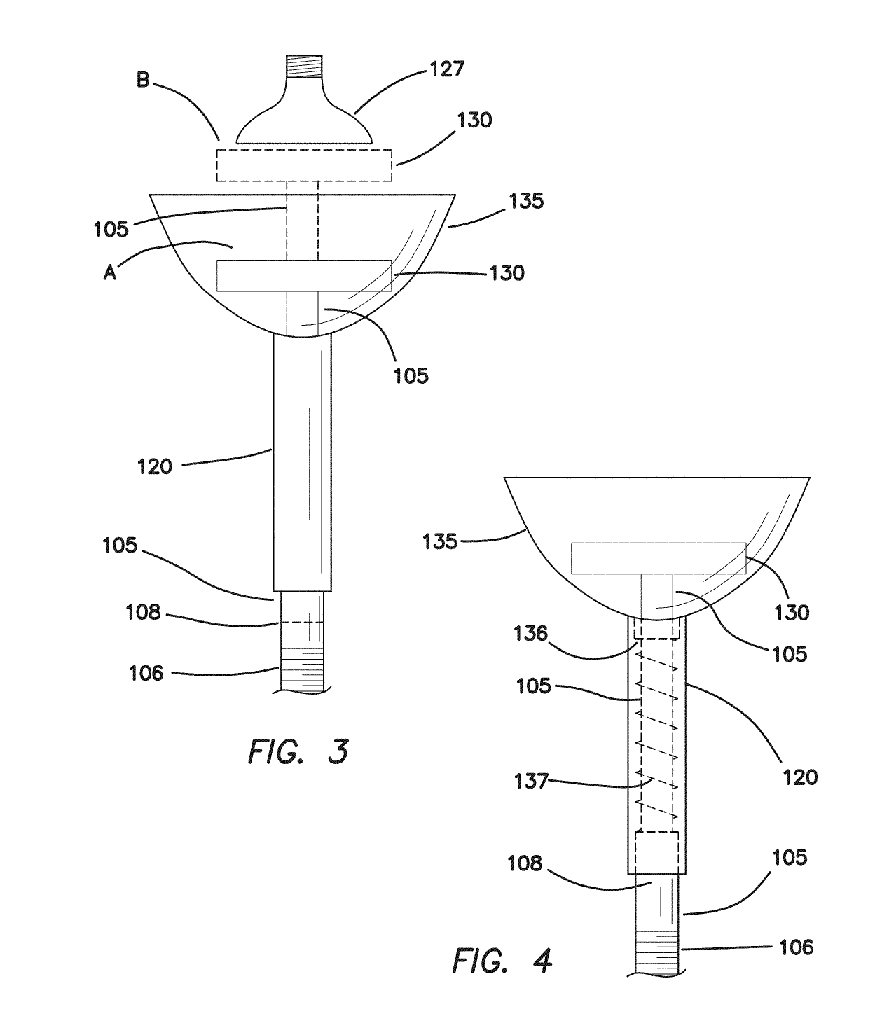

FIGS. 1, 2A and 2B show an apparatus 100 for removing and installing light bulbs, normally from elevated locations such as exterior lights and interior lights recessed in high ceilings. The apparatus 100 comprises broadly a spring-biased translatable member 105 configured to attach to a pole 106 at a first end and a gripping unit 115 at a second end. The pole 106 may include a handle with finger indentations to accommodate a user's hand comfortably. The pole 106 may be telescoping to permit the apparatus 100 to be extended to accommodate various structures and lighting systems.

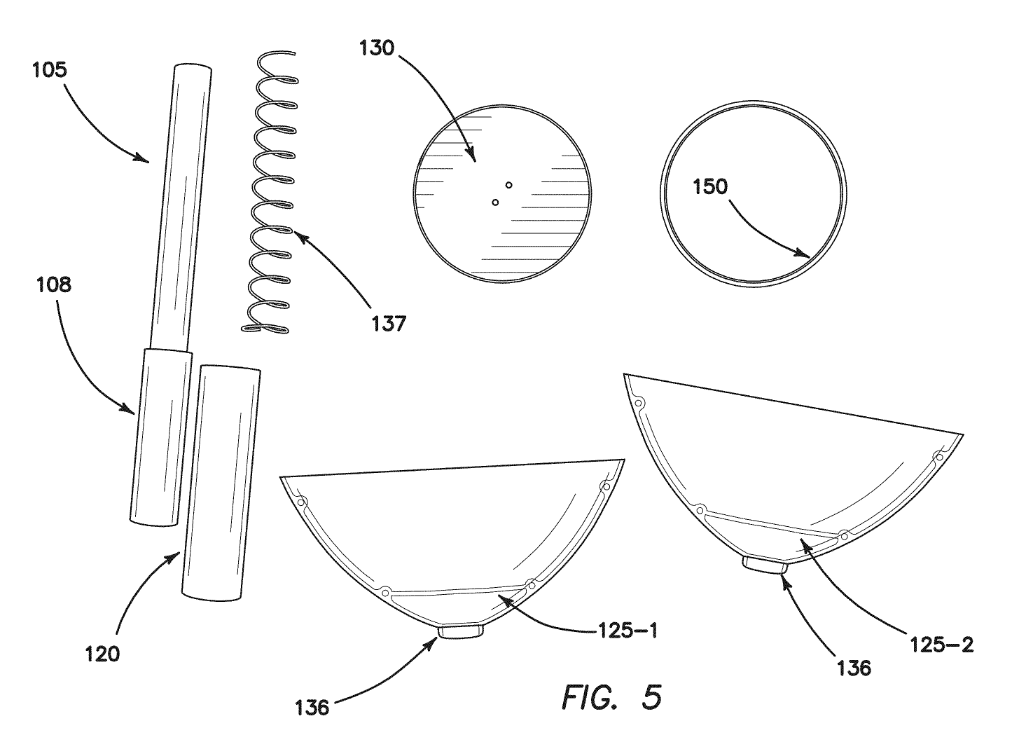

The spring-biased translatable member 105 inserts through a collar 120 attached at a first end to a capture cone 125 configured to catch any light bulb which becomes unsecured during the removal or installation of the same. The spring-biased translatable member 105 includes a base 108 and shaft 109 with the base 108 being wider than the shaft. As best seen in FIG. 3, the spring-biased translatable member 105 is able translate through the collar 120 for removing or installing a light bulb. The spring-biased translatable member 105 is attached at a second end to a platform member 130. A capture cone 135 attaches to an upper end of the collar 120. A spring 137 resides within the collar between the spring-biased translatable member 105 and capture cone 135.

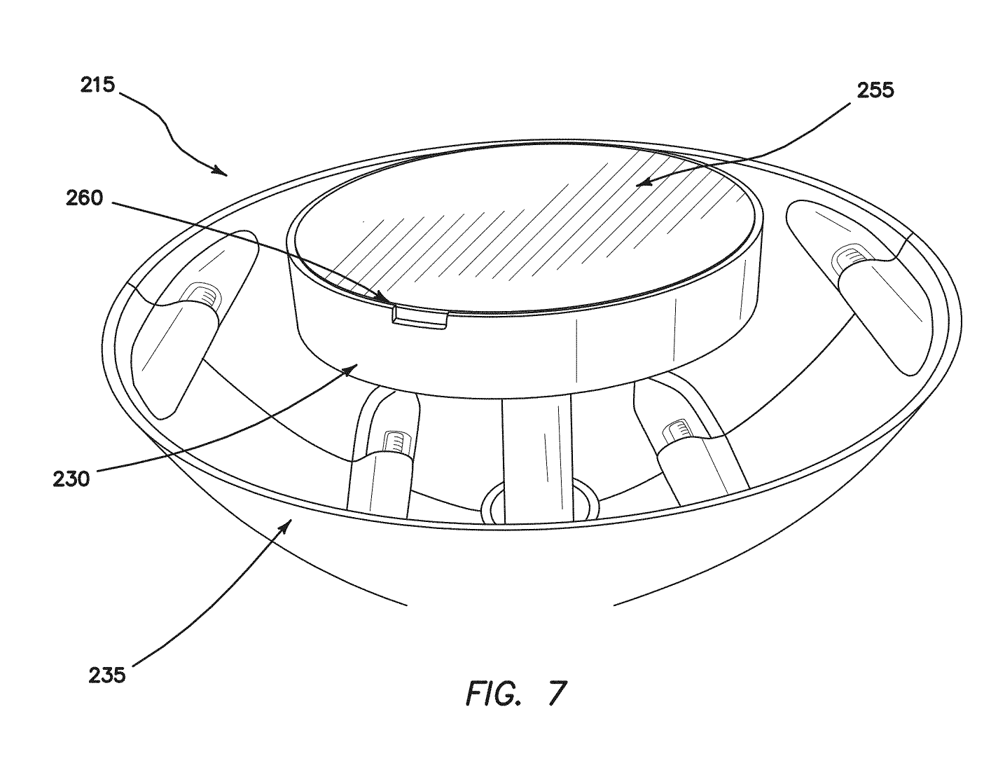

FIG. 3 shows the spring-biased translatable member 105 and attached platform member 130 in a first position (A) and a second position (B) for reasons detailed hereinafter. To remove or install a light bulb the pole 106 is raised such that the capture cone 125 is positioned against a ceiling or recessed light housing at which time the pole 106 may be pushed upward forcing the spring-biased translatable member 105 to which it is connected to slide through said collar 120 compressing the spring 137 between against a stem or bottom 136 (seen in FIG. 4) of said capture cone 135 and said base 108 as the platform member 130 extends making contact with the light 127 (seen in FIG. 3). The spring 137 serves to return the gripping unit 115 to its home position once pressure against the capture cone 135 is released.

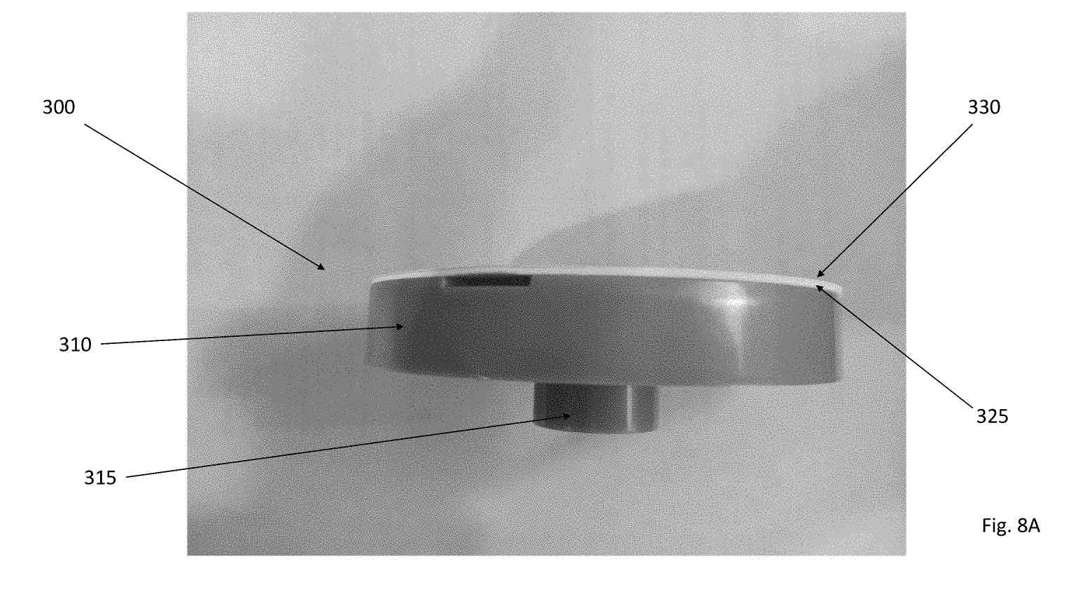

FIG. 5 shows individual components of the capture cone 125 and gripping unit 115. The capture cone 125 comprises two half-cone members 125-1 and 125-2 which fit together to form the capture cone 125. In one embodiment, the two half-cone members 125-1 and 125-2 are joined using screws. The stem 136 extending from a bottom of the assembled capture cone 125 fits into a top of the collar 120. The stem 136 may remain in the top of the collar 120 by means of friction, adhesive, fasteners or the like. The gripping unit 115 comprises the platform member 130 connected to an upper portion of said spring-biased translatable member 105. The platform member 130 includes a raised rim 140 about the circumference of the platform member 130 defining a recessed area 145. While the raised rim 140 is shown as a single continuous rim, it may be intermittent such that spaces within the raised rim exist about the circumference.

FIG. 5 shows a ring 150 configured to connect to platform member 130. FIG. 2B shows the ring 150 disengaged from the platform member 130. The upper edge of the ring 150 forms the raised rim 140. In one embodiment, the ring 150 connects to the platform member 130 via a threaded relationship. Other means, including adhesives, fasteners, friction and the like, of connecting the ring 150 and platform member 130 are conceivable within the spirit and scope of the present invention. FIG. 5 also shows the spring 137, translatable member 105 and collar 120.

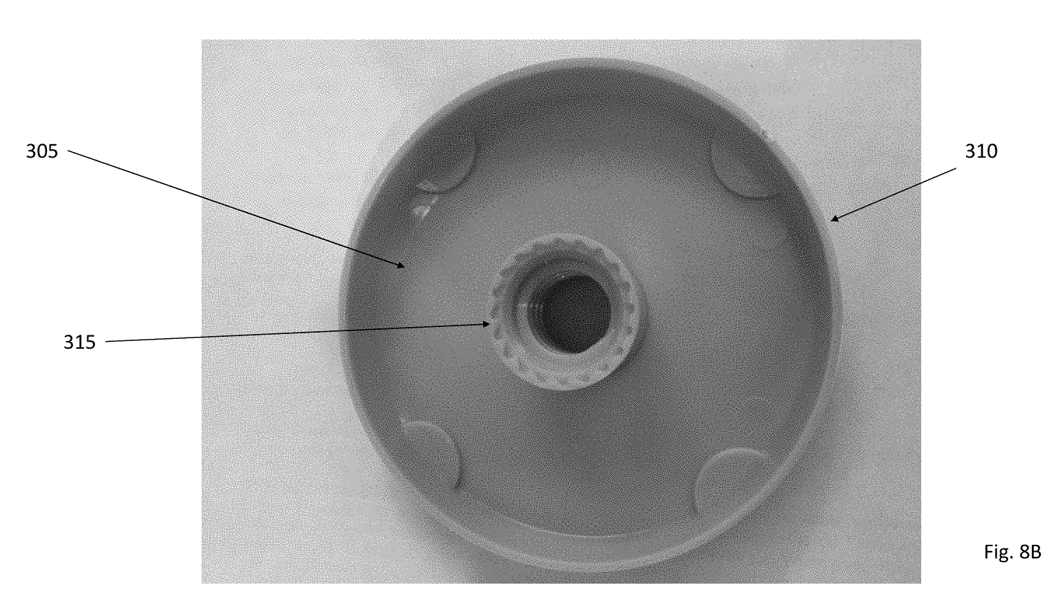

Circular adhesive members 155 (shown in FIG. 6) are dimensioned to reside on the platform member 130 within the recessed area 145. In one embodiment, the adhesive members 155 have two sides of adhesive—a first side holding the adhesive member 155 on the platform member 130 and the second, opposite side for gripping and controlling a light bulb during removal and installation. Removal of the circular adhesive member 155 from the platform member 130 is facilitated by a finger hole 160 on the outer edge of the platform member 130. The finger hole 160 permits the user to grab an edge of the adhesive member 155 and remove it from the platform member 130.

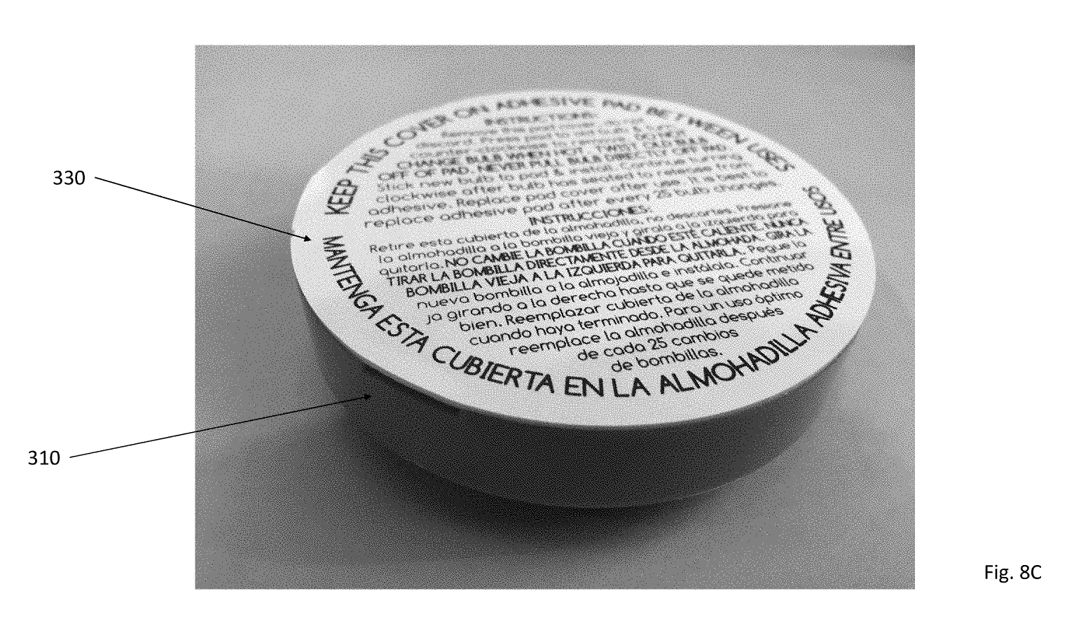

FIG. 7 shows another gripping unit 215 having a capture cone 235 and platform 230. A single adhesive member 255 sits on top of said platform 230. A finger hole 260 permits a user to change out the adhesive member 255.

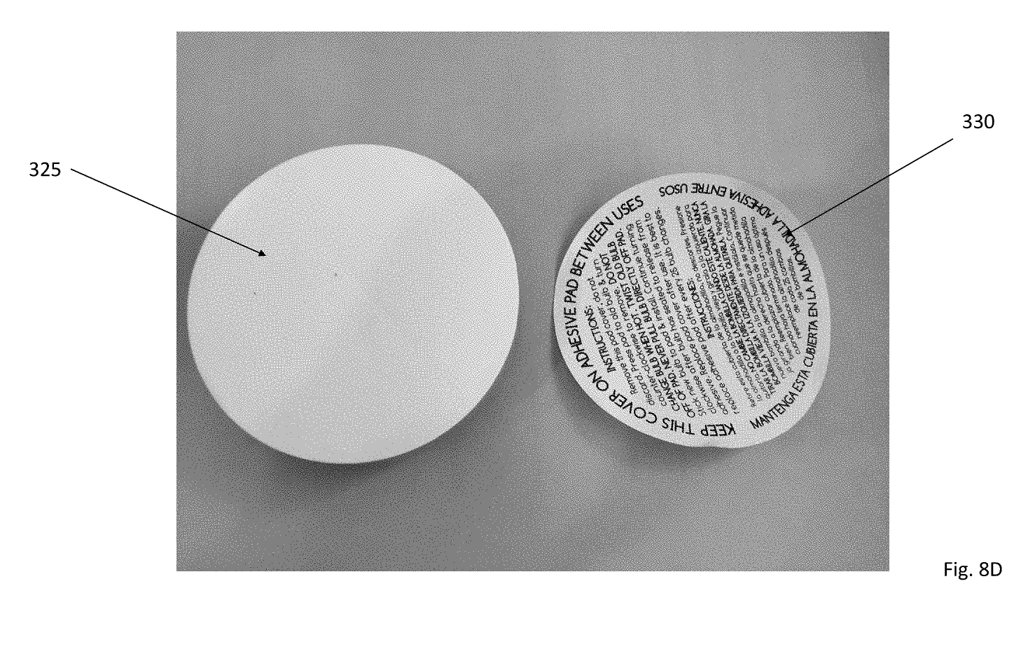

FIGS. 8A through 8C show a universal gripping unit 300 configured to attach to a pole or handle. The universal gripping unit 300 includes a platform 305, collar 310 and threaded female protrusion 315 extending from an underside of the platform 305. The threaded protrusion 315 is configured to receive a threaded male portion of a pole. In this manner, the gripping unit 300 may be attached to poles of varying lengths to accommodate light bulbs at varying elevations or heights. The gripping unit 300 includes a single adhesive pad 325 covered by a non-adhesive sheet 330. Those skilled in the art will recognize that the size and shape of the gripping unit 300 may be altered without departing from the spirit and scope of the present invention.

As shown in FIG. 8D, during use, the non-adhesive sheet 330 is removed, to expose the adhesive pad 325 for removing and installing light bulbs. The non-adhesive sheet 330 is then reattached to the adhesive pad 325 has undertaken its tasks. Such an embodiment allows the adhesive pad 325 to be used numerous times before the adhesive pad 325 needs to be disposed and replaced with a new one.

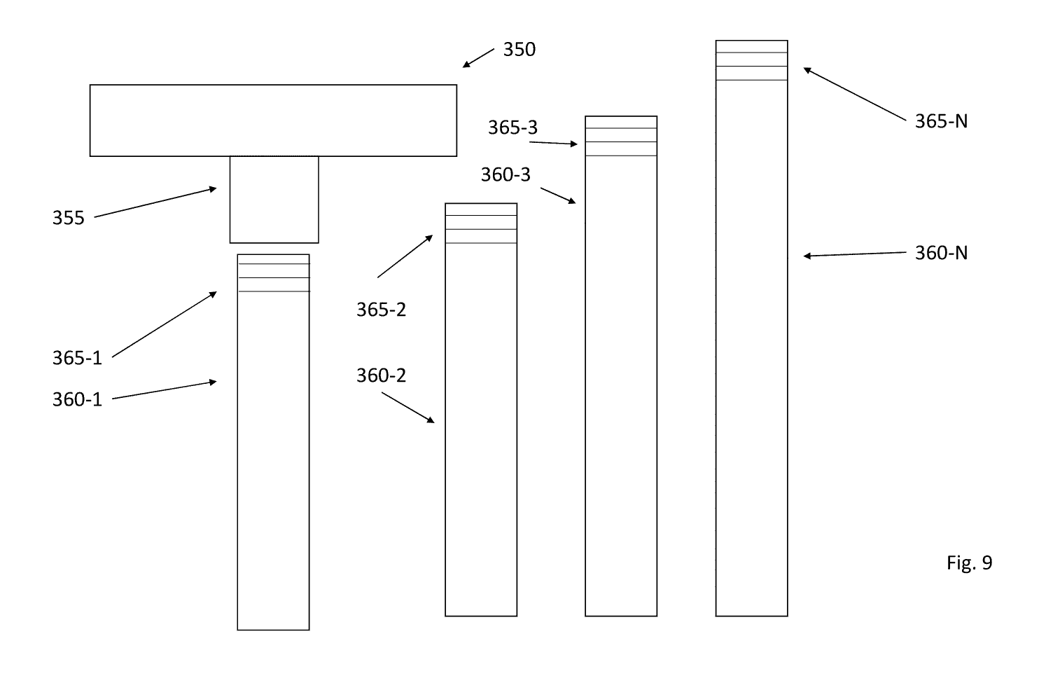

FIG. 9 shows a universal gripping unit 350 and series of poles 360-1 through 360-N to which the gripping unit 350 may be attached. The threaded female protrusion 355 is configured to receive each of the threaded ends 365-1 through 365-N of the series of poles 360-1 through 360-N. As set forth above, the universal gripping unit 350 permits light bulbs at varying elevations to be removed and installed using a single gripping unit. This is especially helpful given many users will already own a threaded pole to which the gripping unit may be attached thereby eliminating the need for the user to purchase such a pole.

Although the invention has been described in detail with reference to several embodiments, additional variations and modifications exist within the scope and spirit of the invention as described and defined in the following claims.

I claim:

1. A gripping unit comprising:
a platform and collar;
an adhesive pad attached to an upper surface of said platform;
a non-adhesive cover removably attached to said adhesive pad; and
a threaded female protrusion extending from an underside of said platform, said threaded female protrusion configured to receive a threaded male portion of a pole or handle.

2. The apparatus of claim 1 wherein said platform and collar are circular.

3. A system for removing and installing light bulbs, comprising:
two or more poles each having one end comprising a threaded portion; and
a gripping unit comprising:
a platform and collar;
an adhesive pad attached to an upper surface of said platform;
a non-adhesive cover removably attached to said adhesive pad; and
a threaded female protrusion extending from an underside of said platform, said threaded female protrusion configured to receive said threaded portions of each of said two or more poles.

4. The apparatus of claim 3 wherein said platform and collar are circular.
